(19) United States
(12) Patent Application Publication
(10) Pub. No.: US 2011/0153053 A1
(43) Pub. Date: Jun. 23, 2011

(54) APPARATUS FOR CONTROLLING GROWTH RATE OF PLANT IN GREENHOUSE AND CONTROLLING METHOD THEREOF

(75) Inventors: Kyuhyung KIM, Daegu (KR); Gwang Su Kim, Daejeon (KR); Seok-Jin Lee, Daegu (KR); Hyun Woo Lee, Daejeon (KR); Moo Jung Chu, Daejeon (KR); Mangu Kang, Daejeon (KR)

(73) Assignee: Electronics and Telecommunications Research Institute, Daejeon (KR)

(21) Appl. No.: 12/969,569

(22) Filed: Dec. 15, 2010

(30) Foreign Application Priority Data
Dec. 23, 2009 (KR) 10-2009-0130150

(51) Int. Cl. A01G 9/14; G05B 13/02

(52) U.S. Cl. 700/103; 47/17

(57) ABSTRACT

Provided is a plant growth control of an apparatus for controlling a growth rate of a plant growing in a greenhouse having a roof formed of a dye-sensitized panel. In the method, a wavelength of sunlight to pass through the dye-sensitized panel is selected according to external environment information. A wavelength control signal corresponding to the selected wavelength is proved to the dye-sensitized panel.

### CROSS-REFERENCE TO RELATED APPLICATIONS

This U.S. non-provisional patent application claims priority under 35 U.S.C. §119 of Korean Patent Application No. 10-2009-0130150, filed on Dec. 23, 2009, the entire contents of which are hereby incorporated by reference.

### BACKGROUND OF THE INVENTION

The present invention disclosed herein relates to an apparatus for controlling the growth rate of a plant in a greenhouse and a controlling method thereof.

Recently, agricultural products such as vegetables, grains, fruits, flowers, crops for special purposes, and crops for medical purposes are being widely cultivated in the agricultural field. Major growth environmental indexes such as light, temperature, and humidity can be artificially adjusted in a greenhouse. Accordingly, agricultural products can be produced all the year round, and special crops that could not be grown outdoors can be cultivated or produced. This contributes greatly to incomes of farmhouses.

However, great rise and fall of the price of the agricultural products due to a failure of the amount and timing of the shipment of the agricultural products may give disadvantages to both producers and consumers.

### SUMMARY OF THE INVENTION

The present invention provides an apparatus for controlling the growth rate of a plant in a greenhouse to adjust production and shipment timing of a plant, and a controlling method thereof.

Embodiments of the present invention provide plant growth control methods of an apparatus for controlling a growth rate of a plant growing in a greenhouse having a roof formed of a dye-sensitized panel including: selecting a wavelength of sunlight to pass through the dye-sensitized panel according to external environment information; and providing a wavelength control signal corresponding to the selected wavelength to the dye-sensitized panel.

In some embodiments, the external environment information may include information on an expected demand for the plant from a distributor.

In other embodiments, the selecting of the wavelength may include: determining a production of the plant according to the information on the expected demand for the plant and information on an expected production of the plant producible in the greenhouse; and selecting a wavelength of sunlight to pass through the dye-sensitized panel according to the determined production.

In still other embodiments, the selecting of the wavelength may include selecting a wavelength of sunlight to pass through the dye-sensitized panel with reference to a plant growth database storing a correspondence relation between the growth rate of plant and the wavelength of sunlight.

In even other embodiments, the external environment information further may include ambient environment information inside/outside the greenhouse.

In yet other embodiments, the selecting of the wavelength may include selecting a wavelength of sunlight such that at least one of visible ray, infrared ray, and ultraviolet ray does not pass through the dye-sensitized panel according to the external environment information.

In further embodiments, the selecting of the wavelength may include selecting a wavelength of sunlight according to the external environment information such that a wavelength pertaining to a certain range within visible ray of sunlight passes through the dye-sensitized panel, or such that a wavelength pertaining to a certain range does not pass through the dye-sensitized panel.

In other embodiments of the present invention, plant growth control apparatuses include: a dye-sensitized panel used in a roof of a greenhouse; a greenhouse controller selecting a wavelength of sunlight delivered to a plant through the dye-sensitized panel according to external environment information; and a panel controller providing a wavelength control signal corresponding to the selected wavelength to the dye-sensitized panel.

In some embodiments, the external environment information may include information on an expected demand for the plant, provided from a distributor.

In other embodiments, the greenhouse controller may determine a production of the plant according to the information on the expected demand for the plant and information on an expected production of the plant producible in the greenhouse, and may select a wavelength of sunlight to pass through the dye-sensitized panel.

In still other embodiments, the greenhouse controller may include a database storing information on the growth of the plant, and may select a wavelength of sunlight to pass through the dye-sensitized panel according to the determined production, with reference to the database.

In even other embodiments, the greenhouse controller may further include a plurality of sensors for measuring temperature, humidity, intensity of illumination, and carbon dioxide concentration with respect to an ambient environment inside/outside the greenhouse, and may select a wavelength of sunlight to pass through the dye-sensitized panel with reference to information collected from the plurality of sensors.

In yet other embodiments, the greenhouse controller may select a wavelength of sunlight such that at least one of visible ray, infrared ray, and ultraviolet ray does not pass through the dye-sensitized panel according to the external environment information.

In further embodiments, the greenhouse controller may select a wavelength of sunlight according to the external environment information such that a wavelength pertaining to a certain range within visible ray of sunlight passes through the dye-sensitized panel, or such that a wavelength pertaining to a certain range does not pass through the dye-sensitized panel.

In still further embodiments, the greenhouse controller and the panel controller may perform a wireless data communication.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a diagram illustrating a concept of a plant growth control apparatus according to an embodiment of the present invention;

FIG. 2 is a diagram illustrating a plant growth control apparatus according to an embodiment of the present invention;

FIG. 3 is a diagram illustrating a function of a greenhouse controller shown in FIG. 2;

FIG. 4 is a diagram illustrating a plant growth control system including a plant growth control apparatus according to an embodiment of the present invention;

FIG. 5 is a diagram illustrating a function of a greenhouse controller shown in FIG. 4;

FIG. 6 is a flowchart illustrating an operation of an integral controller shown in FIG. 4;

FIG. 7 is a flowchart illustrating an operation of a greenhouse controller shown in FIG. 4; and

FIG. 8 is a diagram illustrating a flow of a signal in a plant growth control system including a greenhouse plant growth control apparatus according to an embodiment of the present invention.

### DETAILED DESCRIPTION OF PREFERRED EMBODIMENTS

Hereinafter, it will be described about an exemplary embodiment of the present invention in conjunction with the accompanying drawings.

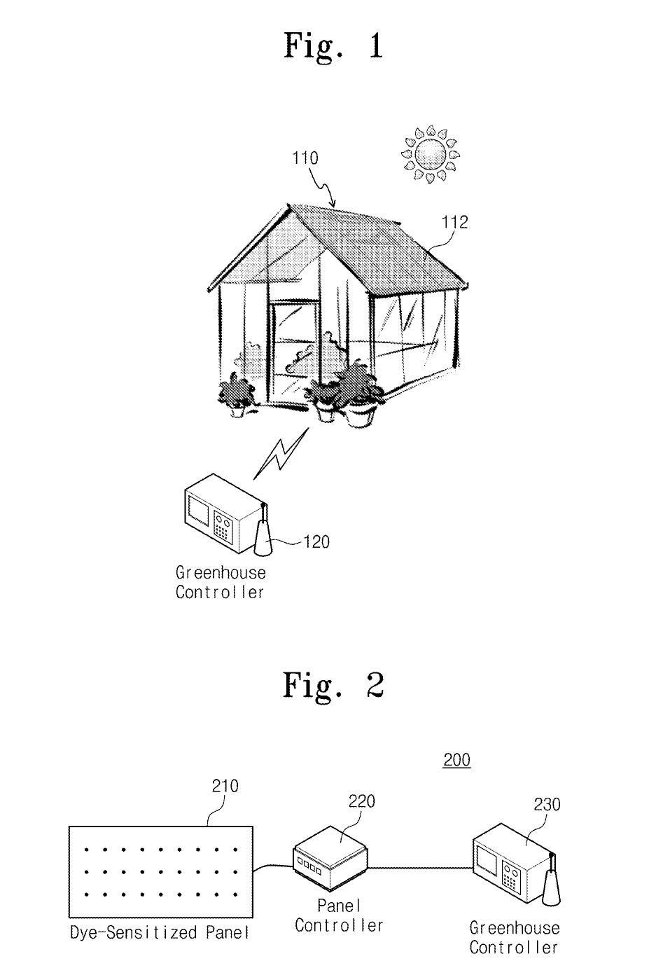

FIG. 1 is a diagram illustrating a concept of a plant growth control apparatus according to an embodiment of the present invention.

Referring to FIG. 1, a greenhouse 110 may be facilities for cultivating plants, which is formed of constructing materials such as vinyl or glass. Examples of plants cultivated in the greenhouse 110 include vegetables, fruits, and flowers. Particularly, a dye-sensitized panel may be installed at the outer wall of the greenhouse 110 according to an embodiment of the present invention. The dye-sensitized panel 112 may be installed over the roof or wall of the greenhouse 110.

Recently, studies on solar cell technologies are being extensively conducted to produce electricity by coating dye on a transparent glass window. The dye-sensitized solar cell may use the principle in which chlorophyll of plant performs photosynthesis by receiving sunlight. If receiving light, the dye-sensitized solar cell generates electrons, the movement of which may generate electricity. Dye may reflect only a specific wavelength of light corresponding to its own color, and may transmit other light. That is, the wavelength of sunlight transmitting light may be different for each dye.

In the present embodiment, the dye-sensitized panel 112 may restrict a desired wavelength of specific band among ultraviolet rays, visible rays, and infrared rays of sunlight based on technology of dye-sensitized solar cells, and may transmit light of other wavelengths.

A greenhouse controller 120 may generate a signal for selecting a wavelength of sunlight passing through the dye-sensitized panel 112 according to external environmental information. The greenhouse controller 120 may generate a signal for selecting a wavelength of sunlight for optimizing the growth rate of plant in the greenhouse 110 according to information such as internal and external temperature, humidity, intensity of illumination, and carbon dioxide concentration of the greenhouse 110. Although not shown in FIG. 1, the plant growth control apparatus may further include a panel controller connected to the dye-sensitized panel 112. The panel controller may control a wavelength of sunlight to pass through the dye-sensitized panel 112 in response to the sunlight wavelength selection signal received from the greenhouse controller 120.

FIG. 2 is a diagram illustrating a plant growth control apparatus according to an embodiment of the present invention.

Referring to FIG. 2, the plant growth control apparatus 200 may include a dye-sensitized panel 210, a panel controller 220, and a greenhouse controller 230. The greenhouse controller 230 may receive information on internal and external temperatures humidity, intensity of illumination, and carbon dioxide concentration of the greenhouse 110, and may generate a wavelength selection signal for selecting a wavelength of sunlight for optimizing the growth rate of plant growing in the greenhouse according to the received information. The panel controller 220 may provide a wavelength control signal corresponding to a wavelength signal received from the greenhouse controller 230 to the dye-sensitized panel 210. The dye-sensitized panel 210 may block a specific band wavelength of sunlight in response to the wavelength control signal. Therefore, plant in the green house may be blocked from a specific band wavelength of sunlight by the dye-sensitized panel 210.

The greenhouse controller 230 and the panel controller 220 may communicate with each other through wireless communication methods such as wireless 1394, Bluetooth, wireless universal serial bus (USB), infrared communication, Wi-Fi, infrared data association (IrDA), as well as wired communication methods. For wireless communication, the greenhouse controller 230 and the panel controller 220 have to include a communication interface suitable for a selected wireless communication method, respectively.

Since a method for manufacturing the dye-sensitized panel 210 or a method for controlling a wavelength of sunlight passing through the dye-sensitized panel 210 may be variously implemented, it will be generally described in the present disclosure that the wavelength of sunlight passing through the dye-sensitized panel 210 can be controlled by the panel controller 220.

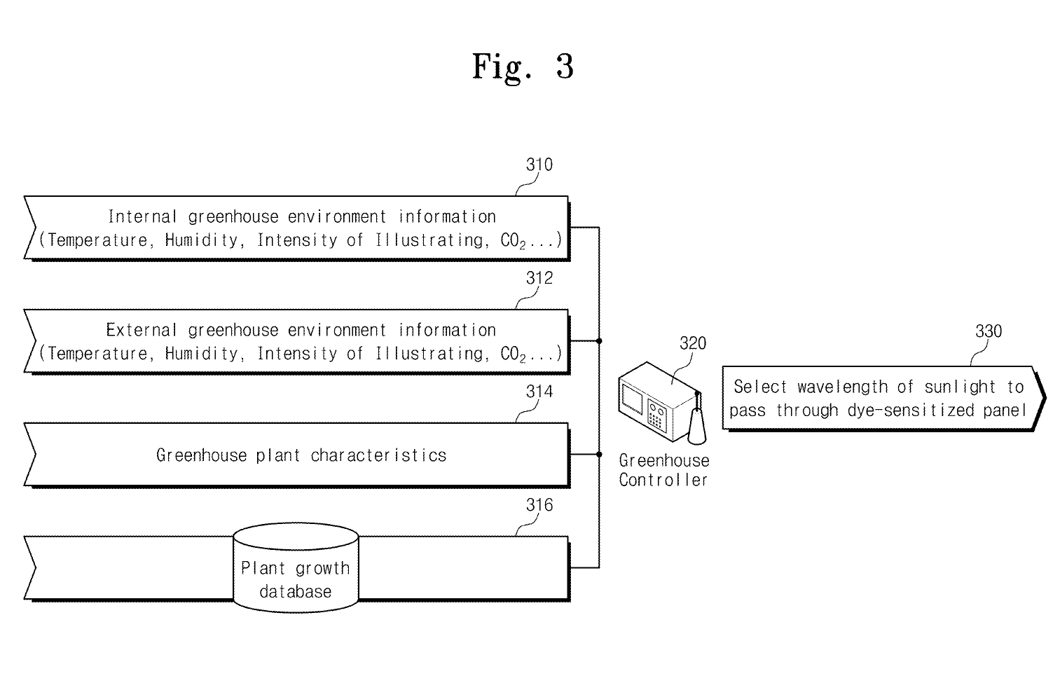

FIG. 3 is a diagram illustrating a function of the greenhouse controller shown in FIG. 2.

Referring to FIG. 3, a greenhouse controller 320 may receive internal greenhouse environment information 310. The internal greenhouse environment information 310 may be acquired by a plurality of sensors (not shown). For example, the internal greenhouse environment information 310 may include sensed signals inputted from thermometer, hygrometer, light sensor, and CO2 concentration sensor. The greenhouse controller 320 may receive external greenhouse environment information 312. The external greenhouse environment information 312 may be acquired by a plurality of sensors (not shown). For example, the external greenhouse environment information 312 may be sensed signals inputted from thermometer, hygrometer, light sensor, and CO2 concentration sensor. The greenhouse controller 320 may receive the characteristic information of plant cultivated in the greenhouse through other input devices. The greenhouse controller 320 may refer to a plant growth database 316 to select an optimal sunlight wavelength necessary for plant cultivated in the greenhouse.

For example, light of about 660 nm wavelength may be blocked to promote the photosynthesis and control the flowering timing of plant cultivated in the green house, and light of about 730 nm wavelength may be blocked to increase the population of fruits, sugar content, and saponin. Also, a wavelength of about 450 nm may be blocked to prevent premature growth of vegetables and young plants, and wavelengths of about 530 nm and about 570 nm may be blocked to inhibit fungi and harmful insects. The whole of visible ray may be blocked with respect to crops such as mushrooms and ginsengs that require minimum visible ray. Ultraviolet region may be blocked to promote generation of anti-oxidants according to plants, and infrared region may be blocked to reduce cooling cost and promote growth in summer The plant growth database 316 may store various data regarding the optical sunlight wavelength according to the growth steps of plant

The greenhouse controller 320 may predict the growth rate of plant by referring to the internal greenhouse environment information 310, the external greenhouse environment information 320, the greenhouse plant characteristics 314, and the plant growth database 316, and may select a wavelength of sunlight to pass the dye-sensitized panel such that plant can grow at a desire rate (330). For example, the greenhouse controller 320 may select a sunlight wavelength such that at least one of visible ray, infrared ray, and ultraviolet ray may not pass through the dye-sensitized panel. Also, the greenhouse controller 320 may select a sunlight wavelength such that a wavelength pertaining to a certain range within visible ray may pass through the dye-sensitized panel, or such that a wavelength pertaining to a certain range may not pass through the dye-sensitized panel.

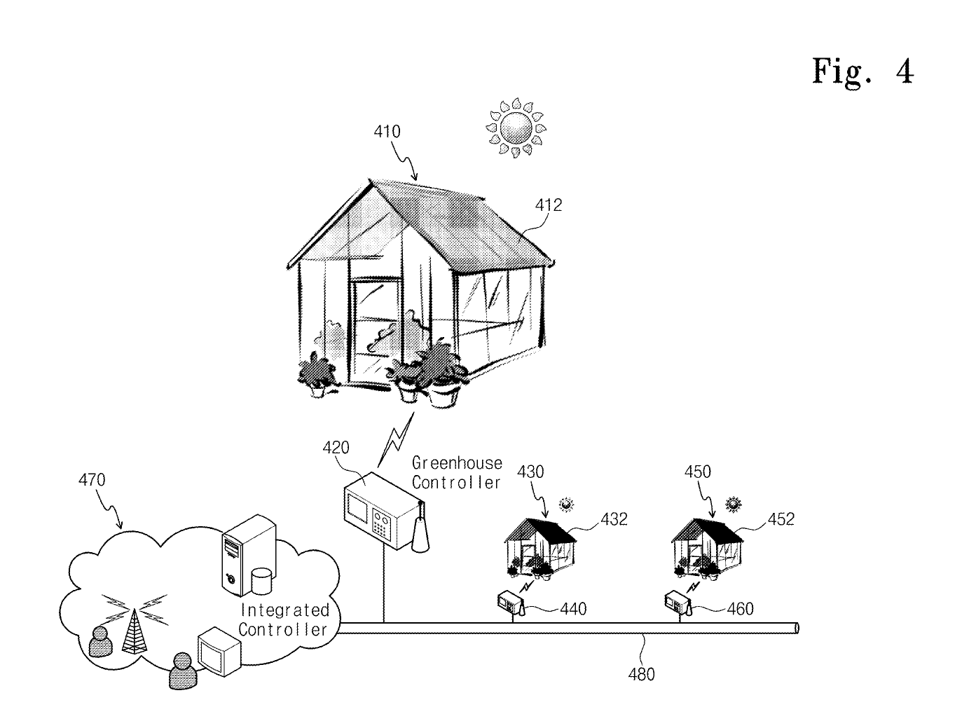

FIG. 4 is a diagram illustrating a plant growth control system including a plant growth control apparatus according to an embodiment of the present invention.

Referring to FIG. 4, the plant growth control system may include a plurality of greenhouses 410, 430 and 450, a plurality of greenhouse controllers 420, 440 and 460, and an integrated controller 470. The plurality of greenhouse controllers 420, 440 and 460 may correspond to the plurality of greenhouses 410, 430 and 450, respectively. The plurality of greenhouses 410, 430 and 450 may include dye-sensitized panel 412, 432 and 452, respectively. The dye-sensitized panels 412, 432 and 452 may be used as materials constituting the roof and outer wall of the greenhouses 410, 430 and 450, respectively.

The integrated controller 470 may be a computer and a computer server managed by an agricultural product distributor such as National Agricultural Cooperative Federation (NACF). The integrated controller 470 may be connected to NACF branches, dealers, and discount stores all over the country through wirer/wireless networks to perform functions of collecting, processing and storing data on trading volume, shipment, and order of plants that are traded in the markets. The integrated controller 470 may transmit expected demand and price information on plants to the greenhouse controllers 420, 440 and 460 through communication networks such as Internet. The greenhouse controllers 420, 440 and 460 may select a wavelength of sunlight to pass the dye-sensitized panels 412, 432 and 452 provided in the corresponding greenhouses 410, 430 and 450 according to the expected demands and price information provided from the integrated controller 470, respectively. Therefore, the present invention can control the growth rate of plants cultivated in the greenhouses 410, 430 and 450 with reference to the expected demands and price information provided from the integrated controller 470.

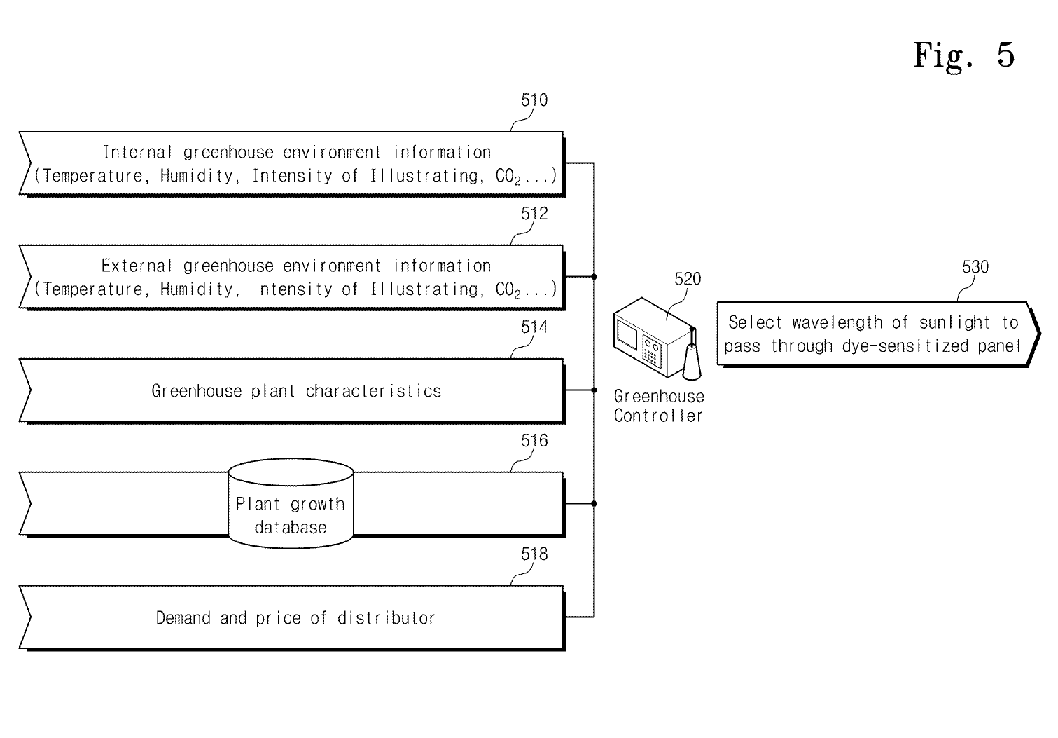

FIG. 5 is a diagram illustrating a function of a greenhouse controller shown in FIG. 4.

Referring to FIG. 5, a greenhouse controller 520 may receive internal greenhouse environment information 510. The internal greenhouse environment information 510 may be acquired by a plurality of sensors (not shown). For example, the internal greenhouse environment information 510 may include sensed signals inputted from thermometer, hygrometer, light sensor, and CO2 concentration sensor. The greenhouse 520 may receive external greenhouse environment information 512. The external greenhouse environment information 512 may be acquired by a plurality of sensors (not shown). For example, the external greenhouse environment information 512 may include sensed signals inputted from thermometer, hygrometer, light sensor, and CO2 concentration sensor. The greenhouse controller 520 may receive characteristic information of plants cultivated in the greenhouse through other input devices. The greenhouse controller 520 may refer to a plant growth database 516 for selecting an optimal sunlight wavelength necessary for plants cultivated in the greenhouse. The greenhouse controller 520 of the present invention may receive demands and price information 518 of agricultural products, provided from the integrated controller 470 of distributors. The greenhouse controller 520 may select an optimal sunlight wavelength necessary for plant with reference to the internal greenhouse environment information 510, the external greenhouse environment information 512, the greenhouse plant characteristic information 514, the plant growth database 516, and the demands and price information 518 of the distributors.

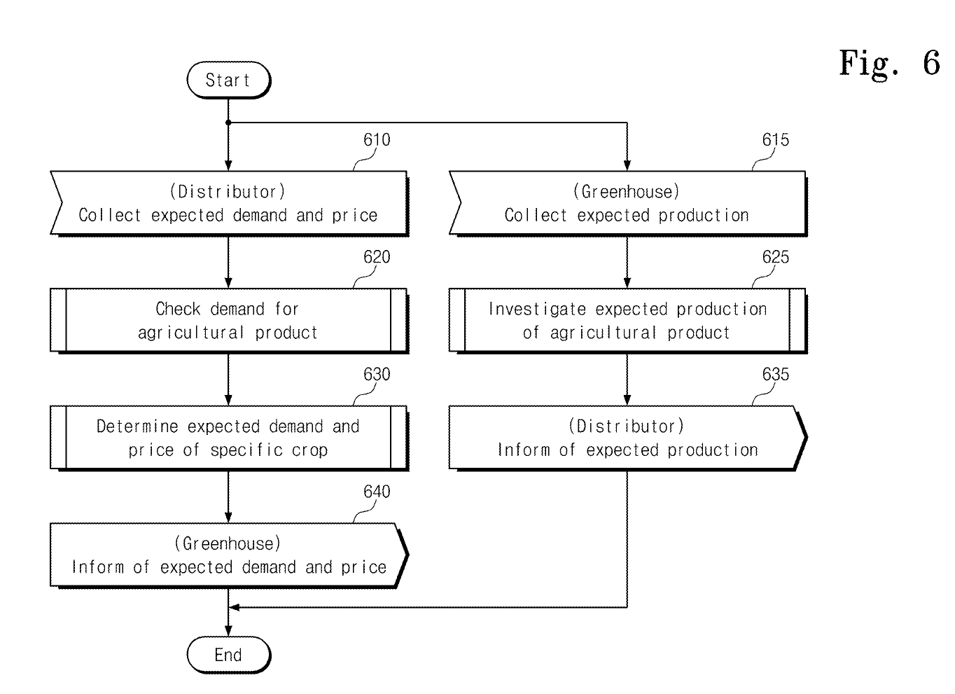

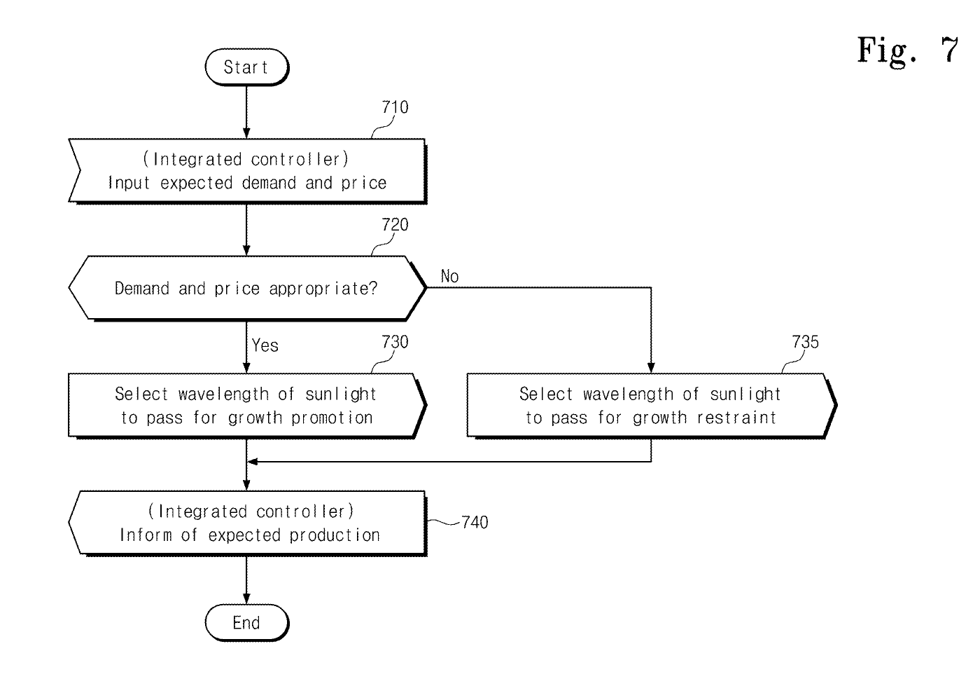

FIG. 6 is a flowchart illustrating an operation of an integral controller shown in FIG. 4. In FIG. plants cultivated in a greenhouse may be described as agricultural products such as vegetables, grains, fruits, flowers, crops for special purposes, and crops for medical purposes.

Referring to FIG. 6, in operation S610, the integrated controller (470 of FIG. 4) may collect expected demands and price information of the agricultural products. The integrated controller 470 may be connected to NACF branches, dealers, and discount stores all over the country through wirer/wireless networks to perform functions of collecting, processing and storing data on trading volume, shipment, and order of plants that are traded in the markets. In operation S620, the integrated controller 470 may check demands of the agricultural products from data collected by terminals. In operation S630, the integrated controller 470 may determine expected demands and price of a specific crop. The integrated controller 470 may transmit the expected demands and price of the specific crop to a greenhouse controller corresponding to the greenhouse in which the crop is being cultivated.

On the other hand, in operation S615, the integrated controller 470 may collect expected production from the greenhouse controllers 420, 440 and 460. In operation S625, the integrated controller 470 may investigate the expected production of the overall agricultural products based on the expected production collected from the respective greenhouse controllers 420, 440 and 460. The integrated controller 470 may inform distributors of the expected production that has been investigated. Accordingly, the distributors may make various efforts for price stability of the agricultural products according to the expected production.

FIG. 7 is a flowchart illustrating an operation of a greenhouse controller shown in FIG. 4.

The greenhouse controller 420 shown in FIG. 4 is described as an example in FIG. 7, but operations of the other greenhouse controllers 440 and 460 are similar to that of the greenhouse controller 420. Referring to FIG. 7, in operation S710, the greenhouse controller 420 may receive expected demands and price of agricultural products from the integrated controller 470. In operation S720, the greenhouse controller 420 may determine whether the received expected demands and price of the agricultural products are appropriate or not. In operation S730, if the expected demands and price of the agricultural products are appropriate, the greenhouse controller 420 may select a wavelength of sunlight to pass through the dye-sensitized panel 412 corresponding to a wavelength necessary for growth promotion of plant. Accordingly, the shipment of the agricultural products growing in the greenhouse 410 can be advanced. If the expected demands and price of the agricultural products is not appropriate (for example, if demand is small or price is low), the greenhouse controller 420 may select a wavelength of sunlight to pass through the dye-sensitized panel 412 corresponding to a wavelength necessary for growth restraint of plant. Therefore, the shipment of the agricultural products growing in the greenhouse 410 can be delayed.

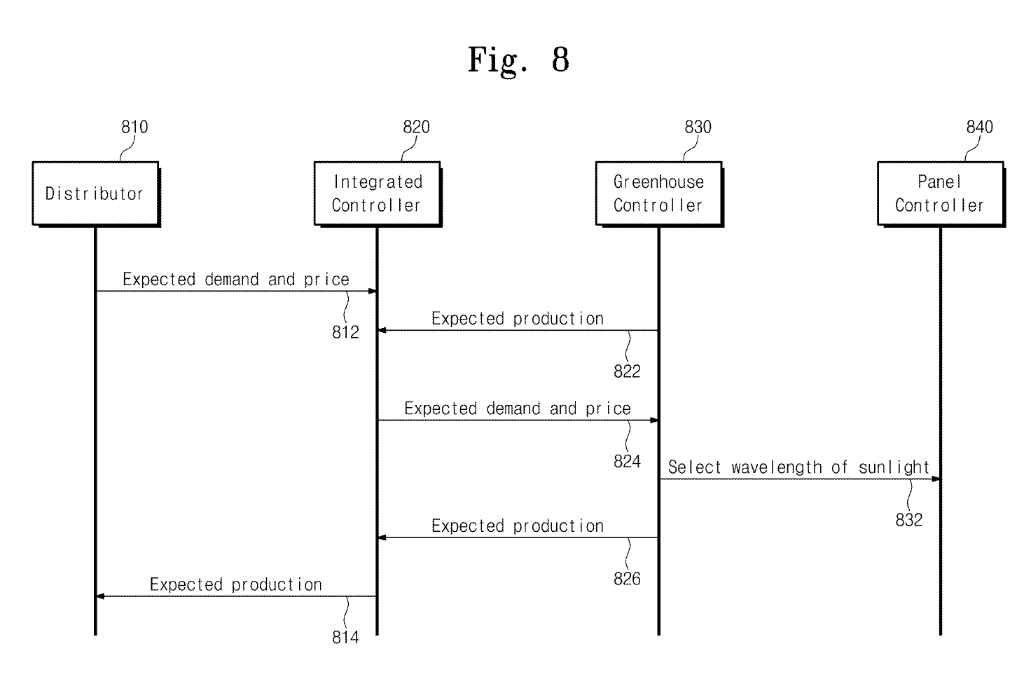

FIG. 8 is a diagram illustrating a flow of a signal in a plant growth control system including a greenhouse plant growth control apparatus according to an embodiment of the present invention.

Referring to FIG. 8, a distributor 810 such as NACF, mart, department store, and wholesale broker may transmit expected demands and price of agricultural products to an integrated controller 820 (812). The distributor 810 may further provide the integrate controller 820 with information on current order, price, and sales volume, as well as the expected demands and price. A greenhouse controller 830 may provide the integrated controller 820 with information on the expected production of the agricultural products growing in the green house (822). In this case, the integrated controller 820 may collect information on the expected production from a plurality of greenhouse controllers.

The integrated controller 820 may analyze the expected demands and price collected from terminals of the distributor 810 and the information on the expected production collected from the greenhouse controller 830 to predict the final expected demands and price. The integrated controller 820 may provide information on the final expected demands and price to the greenhouse controller 830 (824). The greenhouse 830 may select a wavelength of sunlight to pass through a dye-sensitized panel with reference to the final expected demands and price. For example, if the expected demands and price received from the integrated controller 820 are appropriate, a wavelength of sunlight for promoting the growth of plant may be selected. If the expected demands and price are not appropriate, a wavelength of sunlight for delaying the growth of plant may be selected.

The greenhouse controller 830 may provide a sunlight wavelength selection signal to a panel controller 840 (832). The panel controller 840 may control a wavelength of sunlight passing through the dye-sensitized panel in response to the sunlight wavelength selection signal received from the greenhouse controller 830. Since the shipment timing of the agricultural products is adjusted according to the control of the wavelength of sunlight passing through the dye-sensitized panel, the greenhouse 830 may provide modified expected production to the integrated controller 820. The integrated controller 820 may unify the expected production from a plurality of greenhouse controllers including the greenhouse controller 830 to provide the expect production to the distributor 810. Therefore, the distributor 810 can predict the price fluctuation range according to the information on the expected production, and can prepare a countermeasure thereagainst.

According to an embodiment of the present invention, the growth rate of plant can be adjusted by controlling a wavelength of sunlight reaching the plant in a greenhouse in consideration of expected demand and expected production, and therefore the price stability of agricultural products can be achieved. That is, a heavy fall of price can be minimized for the farmhouses producing agricultural products, damage by a great rise of price due to reduction of production can be minimized for consumers. Also, efficiency of sales can be achieved for distributors, by referring to information on expected demand, priced, and expected production of agricultural products.

According to an embodiment of the present invention, the growth rate of plant in a greenhouse can be adjusted by controlling the wavelength of sunlight passing through a dye-sensitized panel. Since the growth rate of plant in a greenhouse can be adjusted according to external environment information on demand and production of agricultural products, the stabilization of the price of the agricultural products can be achieved.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A plant growth control method of an apparatus for controlling a growth rate of a plant growing in a greenhouse having a roof formed of a dye-sensitized panel, the method comprising:
selecting a wavelength of sunlight to pass through the dye-sensitized panel according to external environment information; and
providing a wavelength control signal corresponding to the selected wavelength to the dye-sensitized panel.

2. The plant growth control method of claim 1, wherein the external environment information comprises information on an expected demand for the plant from a distributor.

3. The plant growth control method of claim 2, wherein the selecting of the wavelength comprises:
determining a production of the plant according to the information on the expected demand for the plant and information on an expected production of the plant producible in the greenhouse; and
selecting a wavelength of sunlight to pass through the dye-sensitized panel according to the determined production.

4. The plant growth control method of claim 2, wherein the selecting of the wavelength comprises selecting a wavelength of sunlight to pass through the dye-sensitized panel with reference to a plant growth database storing a correspondence relation between the growth rate of plant and the wavelength of sunlight.

5. The plant growth control method of claim 2, wherein the external environment information further comprises ambient environment information inside/outside the greenhouse.

6. The plant growth control method of claim 1, wherein the selecting of the wavelength comprises selecting a wavelength of sunlight such that at least one of visible ray, infrared ray, and ultraviolet ray does not pass through the dye-sensitized panel according to the external environment information.

7. The plant growth control method of claim 1, wherein the selecting of the wavelength comprises selecting a wavelength of sunlight according to the external environment information such that a wavelength pertaining to a certain range within visible ray of sunlight passes through the dye-sensitized panel, or such that a wavelength pertaining to a certain range does not pass through the dye-sensitized panel.

8. A plant growth control apparatus comprising:
a dye-sensitized panel used in a roof of a greenhouse;
a greenhouse controller selecting a wavelength of sunlight delivered to a plant through the dye-sensitized panel according to external environment information; and
a panel controller providing a wavelength control signal corresponding to the selected wavelength to the dye-sensitized panel.

9. The plant growth control apparatus of claim 8, wherein the external environment information comprises information on an expected demand for the plant, provided from a distributor.

10. The plant growth control apparatus of claim 9, wherein the greenhouse controller determines a production of the plant according to the information on the expected demand for the plant and information on an expected production of the plant producible in the greenhouse, and selects a wavelength of sunlight to pass through the dye-sensitized panel.

11. The plant growth control apparatus of claim 10, wherein the greenhouse controller comprises a database storing information on the growth of the plant, and selects a wavelength of sunlight to pass through the dye-sensitized panel according to the determined production, with reference to the database.

12. The plant growth control apparatus of claim 11, wherein the greenhouse controller further comprises a plurality of sensors for measuring temperature, humidity, intensity of illumination, and carbon dioxide concentration with respect to an ambient environment inside/outside the greenhouse, and selects a wavelength of sunlight to pass through the dye-sensitized panel with reference to information collected from the plurality of sensors.

13. The plant growth control apparatus of claim 8, wherein the greenhouse controller selects a wavelength of sunlight such that at least one of visible ray, infrared ray, and ultraviolet ray does not pass through the dye-sensitized panel according to the external environment information.

14. The plant growth control apparatus of claim 8, wherein the greenhouse controller selects a wavelength of sunlight according to the external environment information such that a wavelength pertaining to a certain range within visible ray of sunlight passes through the dye-sensitized panel, or such that a wavelength pertaining to a certain range does not pass through the dye-sensitized panel.

15. The plant growth control apparatus of claim 8, wherein the greenhouse controller and the panel controller perform a wireless data communication.
